(19) United States
(12) Patent Application Publication
(10) Pub. No.: US 2003/0164073 A1
(43) Pub. Date: Sep. 4, 2003

(54) Tool

(76) Inventor: Jin Fu Chen, Taichung (TW)

Correspondence Address: Jin Fu Chen, P.O. BOX 2103, Taichung, TW

(21) Appl. No.: 10/084,956

(22) Filed: Mar. 1, 2002

(51) Int. Cl. B25B 7/12

(52) U.S. Cl. 81/342

(57) ABSTRACT

A tool including two pivotally connected handles and a tool head. The tool head is composed of two clamping members which are pivotally connected. The clamping members are further pivotally connected with the handles to form a double lever structure. When the handles are relatively pivoted, the clamping members are driven and pivoted relative to each other to clamp a work piece. One of the handles has a projecting block, while the other of the handles is formed with at least one slot cooperating with the projecting block. The slot is positioned in the moving path of the projecting block when the handles are relatively pivoted. By means of cooperation between the slot and the projecting block, the pivoting angle of the handles is restricted.

### BACKGROUND OF THE INVENTION

The present invention is related to an improved tool, and more particularly to a tool having double lever structure which can be more conveniently and safely used.

FIGS. 9 and 10 show a conventional double lever tool composed of two symmetrical handles 81, 82 and a tool head 9. The two handles 81, 82 are pivotally connected via a shaft 83. The tool head 9 is composed of two jaws 91, 92 pivotally connected with each other. The bottom end of each jaw 91, 92 is formed with a pivot hole 911, 921 having an opening 912, 922. Two flattened pin 811, 821 are respectively fixedly disposed on the two handles 81, 82. When the two handles 81, 82 are pivoted and opened to a predetermined position, the two flattened pins 811, 821 can be moved out of the pivot holes 911, 921 through the openings 912, 922 as shown in FIG. 10. Accordingly, the tool head can be replaced by another one with different pattern.

A torque spring 84 is fitted on the shaft 83. Two ends 841, 842 of the torque spring 84 respectively extend to abut against the flattened pins 811, 821. By means of the resilient force of the torque spring 84, the two handles 81, 82 are pushed away from each other. The jaws 91, 92 of the tool head 9 are respectively formed with stop faces 913, 914, 923, 924 adjacent to the pivot sections. When the torque spring 84 pushes open the two handles 81, 82, the stop faces 913, 914, 923, 924 of the jaws 91, 92 abut against each other to restrict the open angle of the handles 81, 82 to a maximum angle.

A switch block 85 is pivotally disposed on one handle 82, while the other handle 81 is formed with a stop face 812 corresponding to the switch block 85. When the two handles 81, 82 are closed, the switch block 85 can be rotated to abut against the stop face 812 for stopping the handles 81, 82 from rotating.

The above double-lever tool has a shortcoming as follows:

The stop faces 913, 914, 923, 924 of the jaws 91, 92 abut against each other to restrict the open angle of the handles 81, 82 to a maximum angle. However, the stop faces 913, 914, 923, 924 of the jaws 91, 92 are formed on outer sides of the jaws 91, 92. Therefore, when the torque spring 84 pushes open the handles 81, 82 and the stop faces 913, 914, 923, 924 of the jaws 91, 92 get close to each other, a user's finger is easy to be pinched and injured.

Moreover, as shown in FIG. 11, the switch block 85 lacks any locating structure so that in use, the switch block 85 will freely rotate to stop the lateral side of the handle 81. As a result, a user will be unable to fully hold the handles 81, 82 together. Accordingly, the jaws 91, 92 of the tool head 9 will be unable to tightly clamp a work piece.

When clamping a larger work piece, the two handles 81, 82 must be opened to the maximum angle as shown in FIG. 12. However, the handles 81, 82 are symmetrically outward arched. Therefore, when the user's thumb pulls the handle 81, the user's index finger, ring finger and little finger can hardly pull the other handle 82 and only the middle finger can constrainedly pull the handle 82. Accordingly, it is hard for the user to force and hold the handles 81, 82 together.

When replacing the tool head 9, the user needs to stretch the handles 81, 82 to a large width as shown in FIG. 10, whereby the flattened pins 811, 821 can be moved out of the pivot holes 911, 921 through the openings 912, 922. Under such circumstance, the two ends 841, 842 of the torque spring 84 outward protrude from the handles 81, 82 and tend to impale a user. Furthermore, the handles 81, 82 cannot be truly located at an open angle. Therefore, the user needs to on one hand stretch the handles 81, 82 and on the other hand try to outward pull the tool head 9. Only when the flattened pins 811, 821 are aimed at the openings, the tool head can be detached from the handles. Such operation is quite inconvenient to the user.

### SUMMARY OF THE INVENTION

It is therefore a primary object of the present invention to provide an improved tool in which one of two pivotally connected handles has a projecting block, while the other of the handles is formed with a slot cooperating with the projecting block. By means of cooperation between the slot and the projecting block, the pivoting angle of the handles is restricted to protect a user from being pinched and injured.

It is a further object of the present invention to provide the above an improved tool in which one handle is pivotally provided with a switch block and has a protuberance for stopping the switch block. Therefore, the switch block is prevented from interfering with the holding and closing of the handles.

It is still a further object of the present invention to provide the above improved tool in which one handle has a second grip section having a large arched recess. A user's index finger and middle finger can more easily together pull the second grip section so that the tool can be more conveniently used.

It is still a further object of the present invention to provide the above improved tool in which the handles have stop boards respectively corresponding to the press sections of the torque spring. When the handles are widely opened, the press sections are stopped and restricted by the stop boards of the handles from protruding out of the handles. Accordingly, a user is protected from being impaled.

It is still a further object of the present invention to provide the above improved tool in which the handle with the slot is formed with a dent corresponding to the projecting block of the other handle. When the handles are pivoted to a positioned where the narrowed sections of the pins can be detached and moved out of the pivot holes through the openings, the projecting block is engaged in the dent to locate the handles. Accordingly, the tool head can be more conveniently assembled or disassembled.

The present invention can be best understood through the following description and accompanying drawings wherein:

### BRIEF DESCRIPTION OF THE DRAWINGS

FIG. 1 is a perspective assembled view of the present invention;

FIG. 2 is a partially sectional assembled view of the present invention;

FIG. 3 is an enlarged view of a part of FIG. 2;

FIG. 4 is a view showing the structure of the pivoted sections of the two handles of the present invention;

FIG. 5 is a plane view of the structure of the present invention;

FIG. 6 shows the use of the present invention;

FIG. 7 shows that the handles of the present invention are stretched open and the side boards are resiliently deformed;

FIG. 8 shows that the handles of the present invention are stretched open for assembling or disassembling the tool head;

FIG. 9 shows the structure of a second embodiment of the present invention;

FIG. 10 shows the structure of a third embodiment of the present invention;

FIG. 11 is a view of a conventional double lever tool;

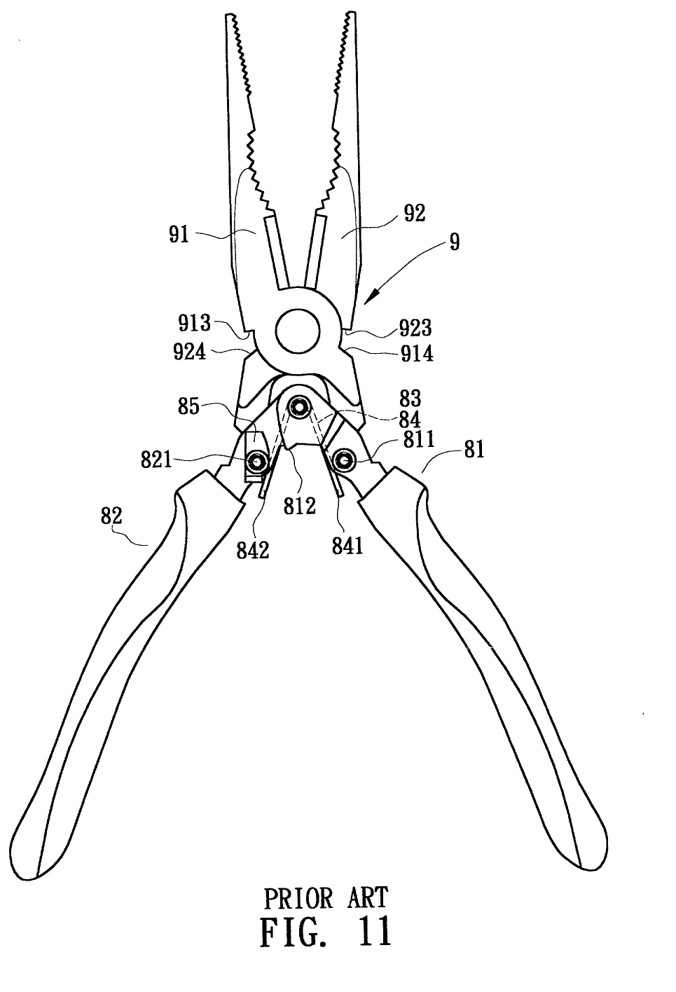

FIG. 12 is a view showing the structure of the conventional double lever tool;

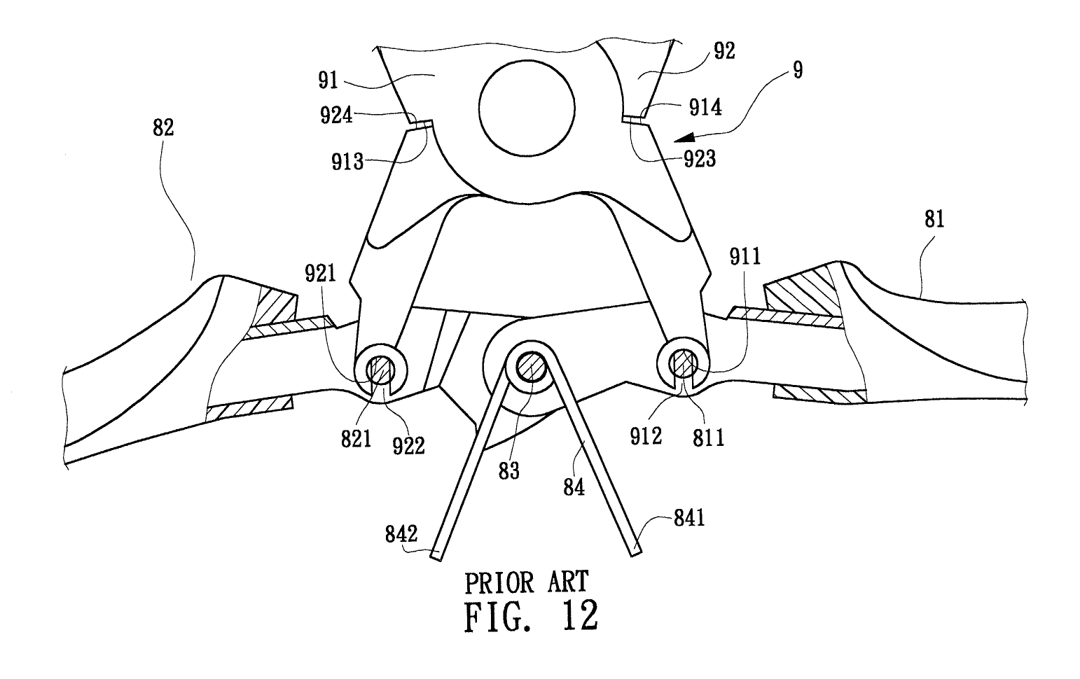

FIG. 13 is a view of the conventional double lever tool, showing that the switch block interferes with the closing of the handles; and

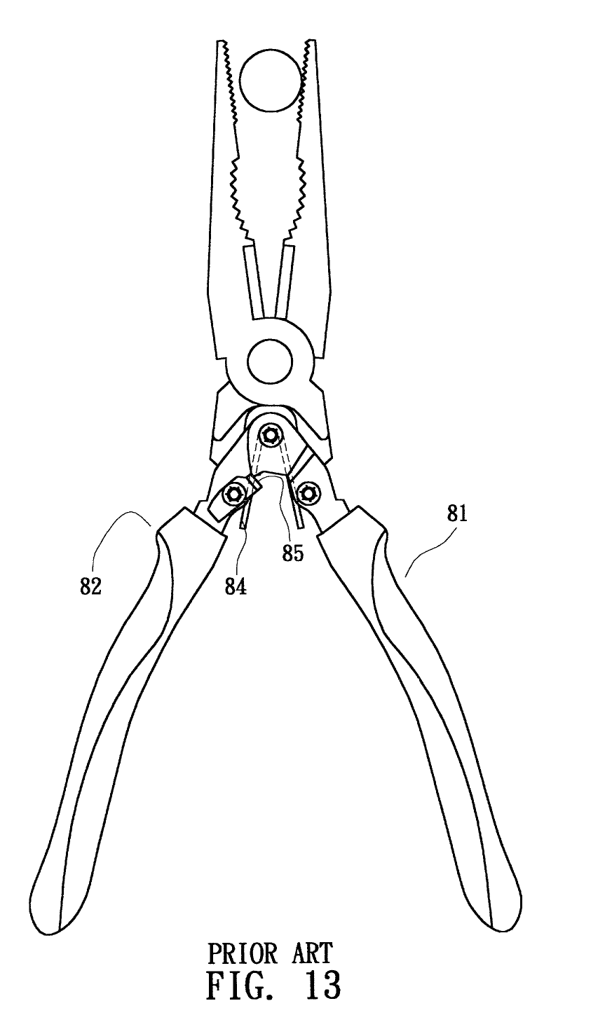

FIG. 14 is a view showing the use of the conventional double lever tool.

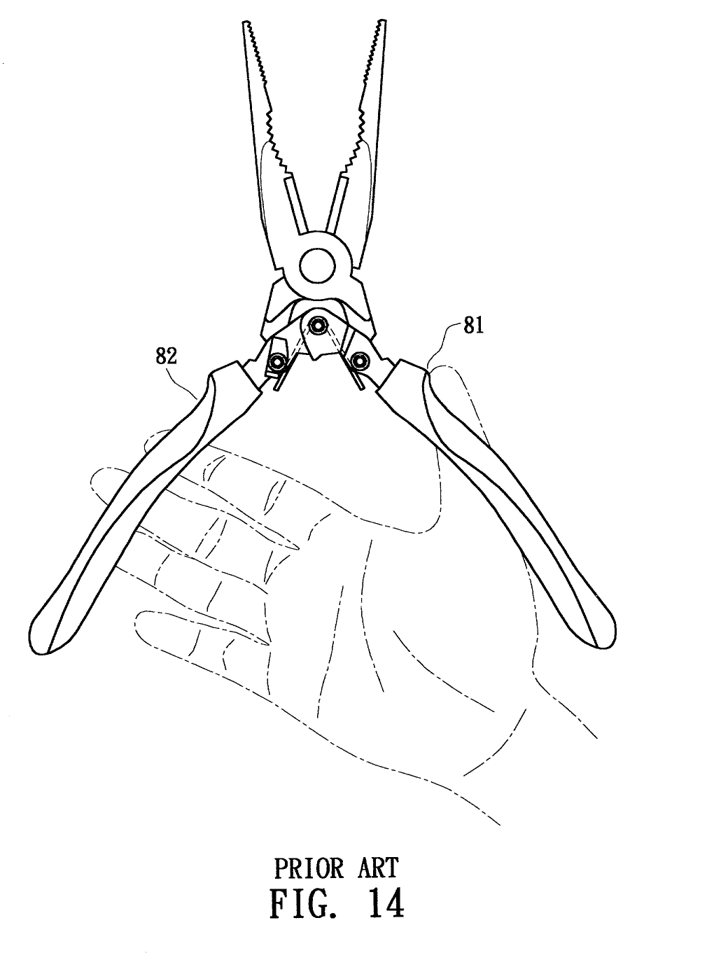

### DETAILED DESCRIPTION OF THE PREFERRED EMBODIMENTS

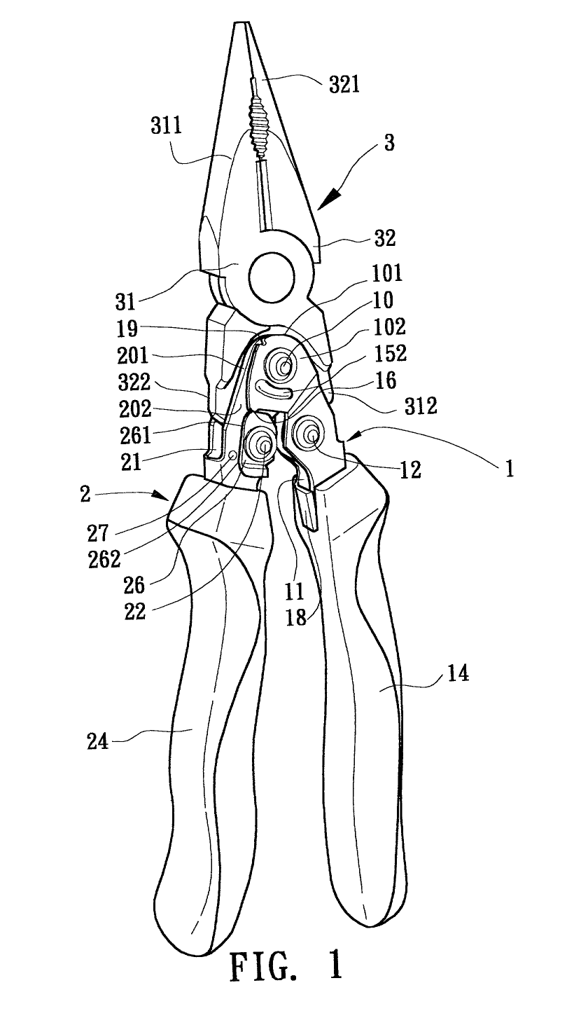

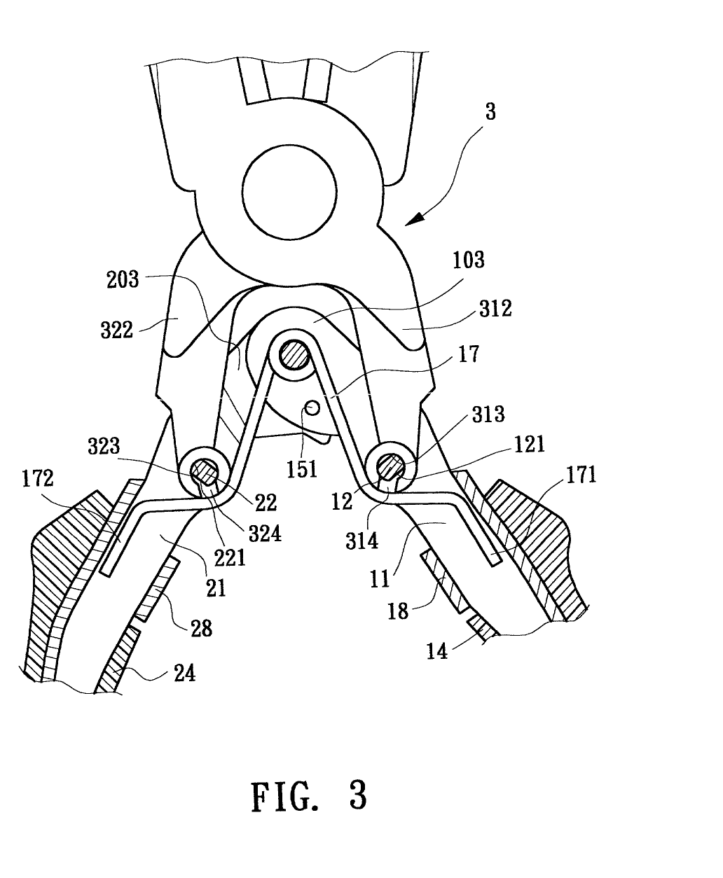

Please refer to FIGS. 1 to 5. The tool of the present invention includes two handles 1, 2 and a tool head 3 pivotally connected with each other.

The tool head 3 is composed of two jaws 31, 32. The middle portions of the jaws 31, 32 are pivotally connected on a pivot shaft 30. One end of each jaw 31, 32 has a clamping section 311, 321. The opposite end of each jaw 31, 32 has a connecting section 312, 322 formed with a pivot hole 313, 323 for pivotally connecting with the handles 1, 2. Each pivot hole 313, 323 has an opening 314, 324.

Each handle 1, 2 has a pivoted end 101, 201. The pivoted ends 101, 201 are pivotally connected with each other on a shaft 10. A section of each handle 1, 2 near the pivoted end 101, 201 is formed with a caved section 11, 21 laterally passing through the handle 1, 2. The handle 1, 2 is divided by the caved section 11, 21 into two side boards 102, 103, 202, 203. A pin 12, 22 is disposed between the side boards 102, 103, 202, 203 of each handles 1, 2. One end of the pin 12 and one end of the pin 22 are respectively fixed on the side boards 102, 203. Each pin 12, 22 has a non-circular cross-section with a narrowed section 121, 221. The openings 314, 324 of the jaws 31, 32 are slightly larger than the narrowed sections 121, 221, whereby the pins 12, 22 can pass through the openings 314, 324 into the pivot holes 313, 323 of the jaws 31, 32. The pivotally connected handles 1, 2 and the pivotally connected jaws 31, 32 of the tool head 3 together form a double lever structure. When the handles 1, 2 are relatively pivoted, the jaws 31, 32 are driven and pivoted relative to each other. At this time, the clamping sections 311, 321 can clamp a work piece.

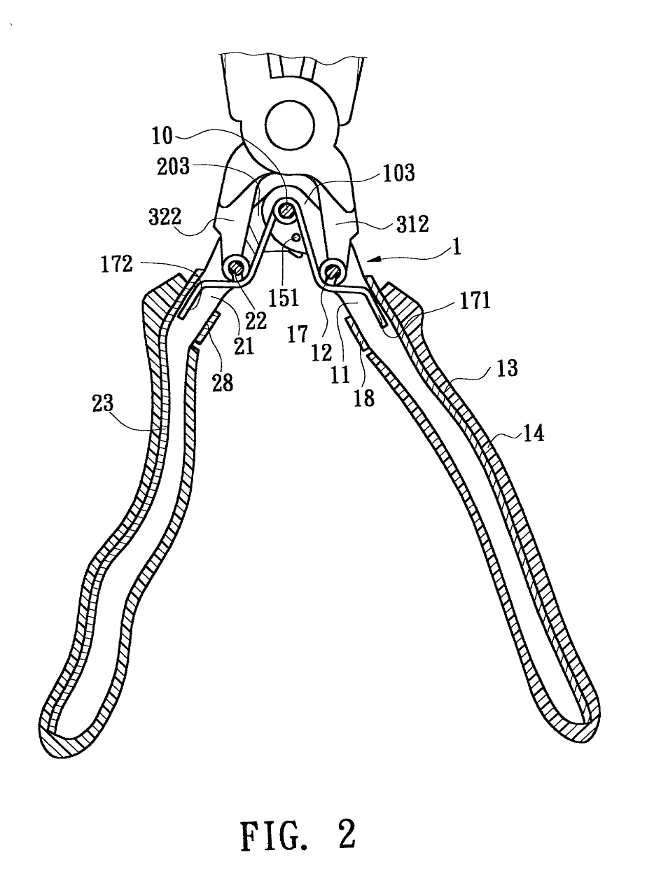

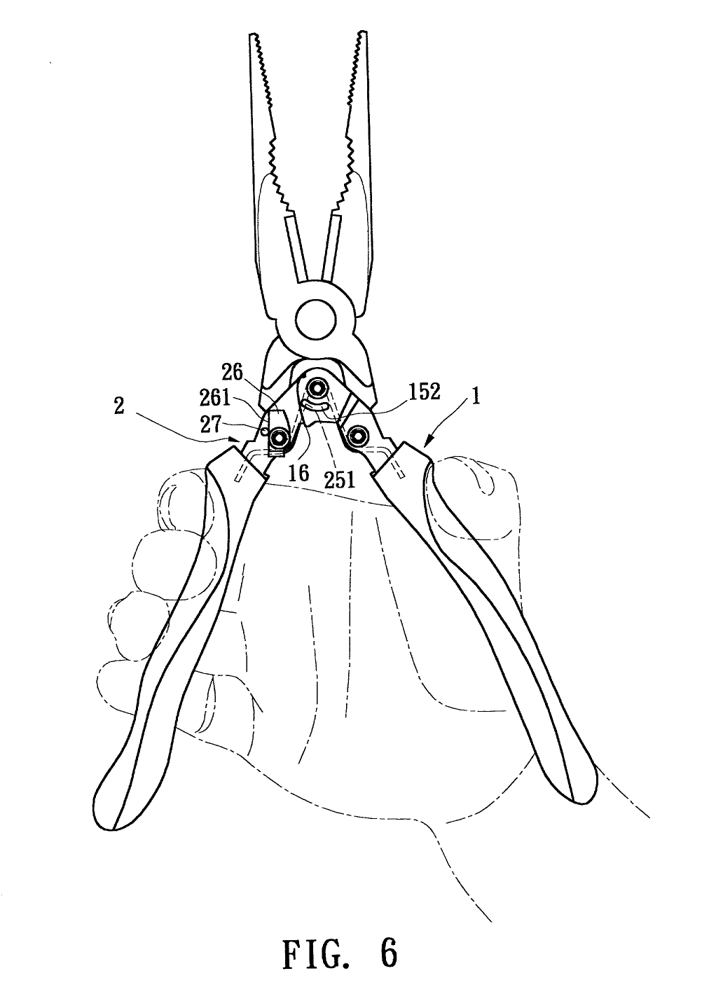

Referring to FIGS. 2 and 6, the handles 1, 2 have asymmetrical patterns. The outer side of a section of the handle 1 near the shaft 10 is formed with a first grip section 13 having small arched recess. A user's thumb can pull the first grip section 13. The outer side of a section of the other handle 2 near the shaft 10 is formed with a second grip section 23 bent toward the first grip section 13 and having larger arched recess. A user's index finger and middle finger can pull the second grip section 23. Two sheaths 14, 24 are respectively fitted on the handles 1, 2. The sheaths 14, 24 have profiles corresponding to the profiles of the handles 1, 2.

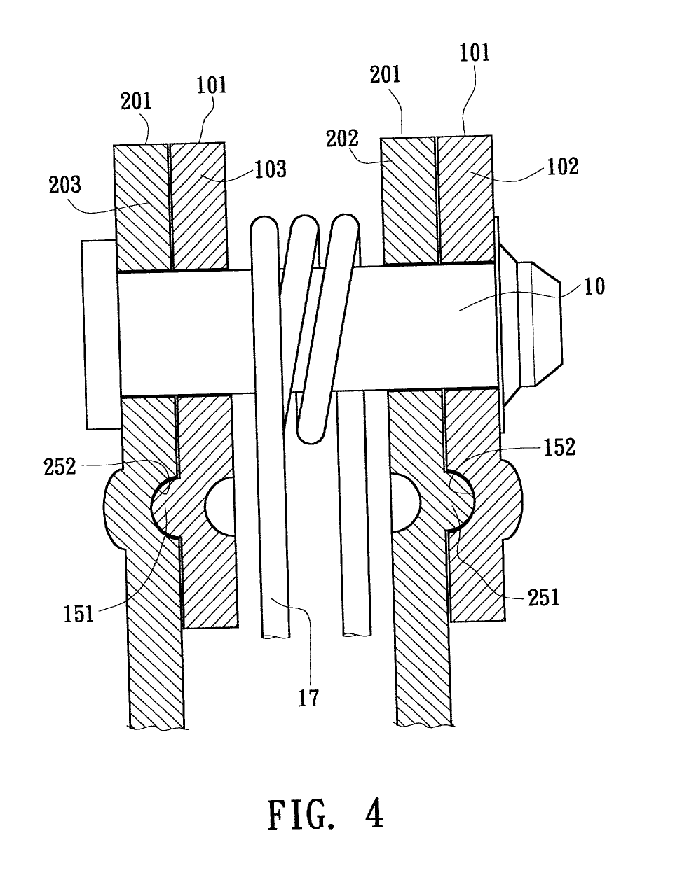

The side boards 103, 202 respectively have two projecting blocks 151, 251. The other side boards 102, 203 are respectively formed with two slots 152, 252 cooperating with the projecting blocks 151, 251. As shown in FIG. 4, the slots 152, 252 are positioned in the moving paths of the projecting block 151, 251 when the handles 1, 2 are relatively pivoted.

By means of cooperation between the slots 152, 252 and the projecting blocks 151, 251, the pivoting range of the handles 1, 2 is restricted. The handles 1, 2 are respectively formed with two dents 19, 29 corresponding to the projecting blocks 151, 251. When the handles 1, 2 are pivoted to a positioned where the narrowed sections 121, 221 of the pins 12, 22 can be detached and moved out of the pivot holes 313, 323 through the openings 314, 324, the projecting blocks 151, 251 are respectively engaged in the dents 19, 29 to locate the handles 1, 2.

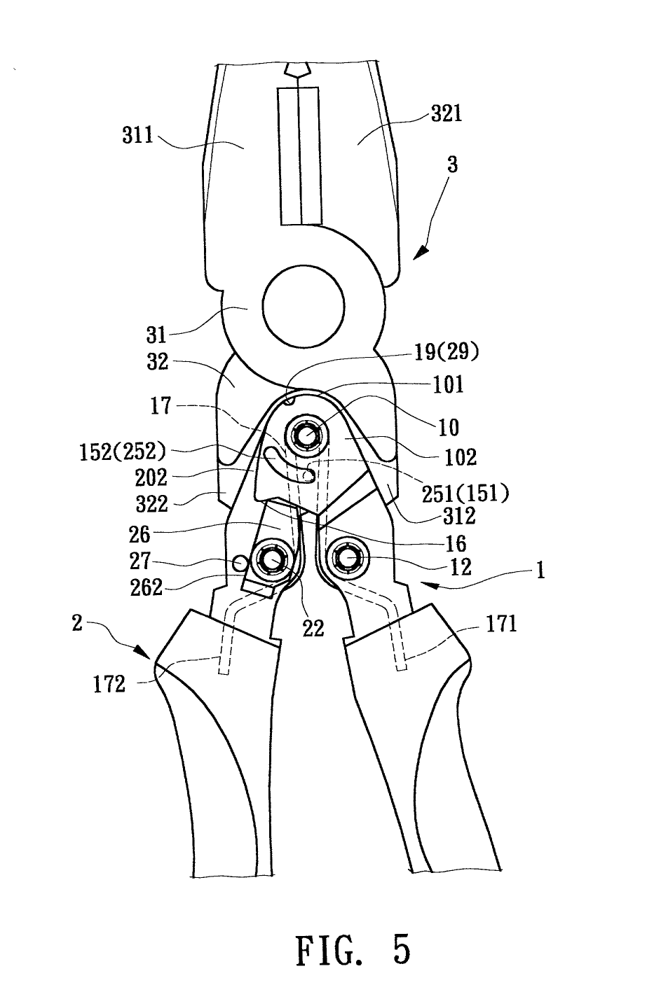

A switch block 26 is coaxially disposed on the handle 2 about the pin 22. The handle 2 has a protuberance 27 on one side of the switch block 26 distal from the handle 1. The switch block 26 can be pivoted to lean against the protuberance 27. The other handle 1 is formed with a stop face 16 corresponding to the switch block 25. One side of the switch block 26 adjacent to the protuberance 27 is defined with a first leaning face 261 and a second leaning face 262 in accordance with the pivoting direction. When the handles 1, 2 are closed, with the second leaning face 262 of the switch block 26 leant against the protuberance 27, the switch block 26 abuts against the stop face 16 to prevent the handles 1, 2 from rotating as shown in FIG. 5. When the switch block 26 is pivoted to lean the first leaning face 261 against the protuberance 27, the switch block 26 will not contact with the stop face 16 as shown in FIG. 6.

A torque spring 17 is fitted on the shaft 10. Two ends of the torque spring 17 extend from the opposite sides of the handles 1, 2 and pass by the pins 12, 22 of the handles 1, 2 and then outward extend to respectively form two press sections 171, 172 inserted in the recesses 11, 21. In addition, the opposite sides of the handles 1, 2 are integrally bent to respectively form two stop boards 18, 28 for stopping and restricting the press sections 171, 172 of the torque spring 17 within the caved sections 11, 21 of the handles 1, 2.

The handles 1, 2 are respectively formed with cooperative slots 152, 252 and projecting blocks 151, 251. The moving range of the projecting blocks 151, 251 is restricted by the slots 152, 252. Accordingly, when the handles 1, 2 are resiliently stretched open by the torque spring 17, the slots 152, 252 restrain the projecting blocks 151, 251 so as to restrict the maximum open angle of the handles 1, 2 as shown in FIG. 6. Therefore, the user's finger is protected from being pinched and injured as in the conventional structure.

The handle 2 has a protuberance 27 on one side of the switch block 26 distal from the handle 1. When the first leaning face 261 of the switch block 26 is leant against the protuberance 27, the switch block 26 will not contact with the stop face 16 of the handle 1. Therefore, the switch block 26 will not unexpectedly rotate to interfere with the closing of the handles 1, 2 and the handles 1, 2 can be freely pivotally rotated.

Moreover, the handles 1, 2 have asymmetrical patterns. The second grip section 23 of the handle 2 is bent toward the handle 1 and has a large arched recess. Accordingly, the distance between the second grip section 23 and the handle 1 is shortened, whereby a user's index finger and middle finger can more easily together pull the handle 2.

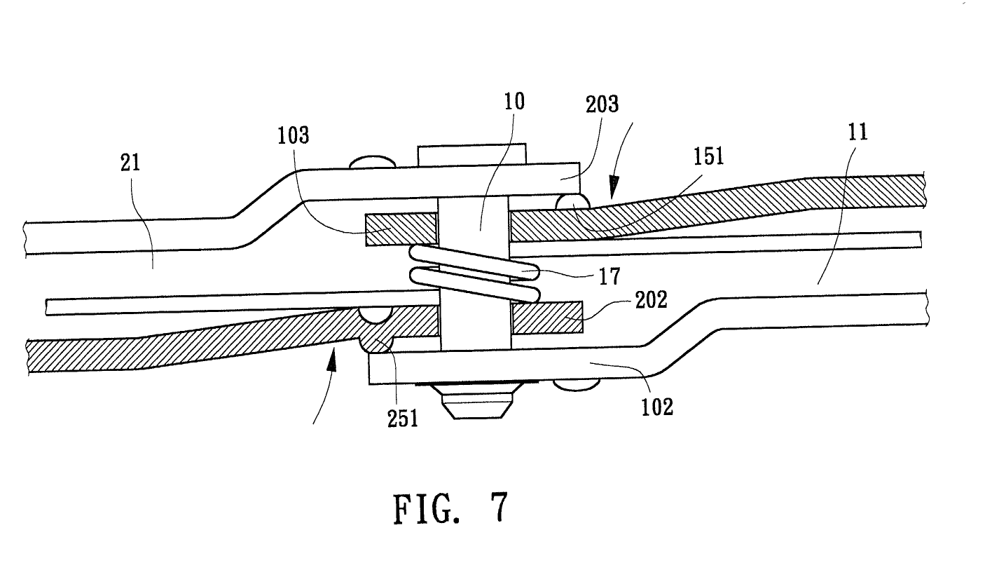

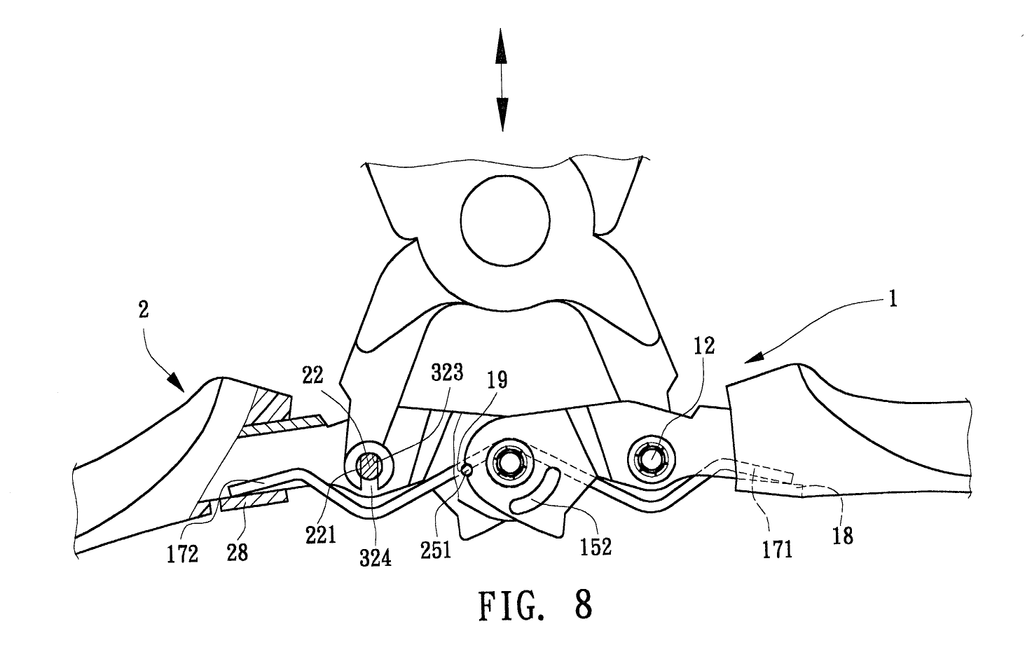

Furthermore, when disassembling the tool head 3, a user needs to forcedly stretch open the handles 1, 2. At this time, the projecting blocks 151, 251 will press the peripheries of the slots 152, 252. The caved sections 11, 21 divide the handles 1, 2 to form the side boards 103, 202 which can be resiliently deformed when suffering a force as shown in FIG. 7. Therefore, the projecting blocks 151, 251 can be detached and moved out of the slots 152, 252. When the handles 1, 2 are widely pivoted to a positioned where the projecting blocks 151, 251 are aimed at the dents 19, 29, the side boards 103, 202 will resiliently restore to make the projecting blocks 151, 251 engaged in the dents 19, 29 so as to locate the handles 1, 2 at a certain open angle. At this time, the narrowed sections 121, 221 of the pins 12, 22 can be detached and moved out of the pivot holes 313, 323 through the openings 314, 324 as shown in FIG. 8. Accordingly, the tool head 3 can be more conveniently assembled or disassembled.

When the handles 1, 2 are widely stretched open, the press sections 171, 172 of the torque spring 17 are stopped and restricted by the stop boards 18, 28 of the handles 1, 2 within the caved sections 11, 21 thereof without protruding out of the handles 1, 2. Accordingly, a user is protected from being impaled.

When the handles 1, 2 are held together, the torque spring 17 is inward pressed by the pins 12, 22 to exert an outward push force onto the handles 1, 2. When the handles 1, 2 are widely opened, the press sections 171, 172 of the torque spring 17 are outward stretched by the stop boards 18, 28 to exert a restricting force onto the handles 1, 2 for pressing the handles 1, 2 toward each other. Therefore, the torque spring 17 serves to resiliently keep the handles 1, 2 opened at a certain angle.

According to the above arrangement, the present invention has the following advantages:

1. By means of cooperation between the slots 152, 252 and the projecting blocks 151, 251 of the handles 1, 2, the pivoting angle of the handles 1, 2 is restricted and a user is protected from being pinched and injured.

2. The handle 2 has a protuberance 27 on one side of the switch block 26 for stopping the switch block 26. Therefore, the switch block 26 is prevented from interfering with the holding and closing of the handles 1, 2.

3. The handle 2 has a second grip section 26 having a large arched recess. Accordingly, a user's index finger and middle finger can more easily together pull the handle 2 and thus the tool can be more conveniently used.

4. The projecting block 25 of the handle 2 can be engaged in the dent 19 of the handle 1 to locate the handles 1, 2 at a certain open angle. Accordingly, the tool head 3 can be more conveniently assembled or disassembled.

5. The handles 1, 2 have stop boards 18, 28 respectively corresponding to the press sections 171, 172 of the torque spring 17, whereby the press sections 171, 172 of the torque spring 17 are restricted by the stop boards 18, 28 from protruding out of the handles 1, 2. Accordingly, a user is protected from being impaled.

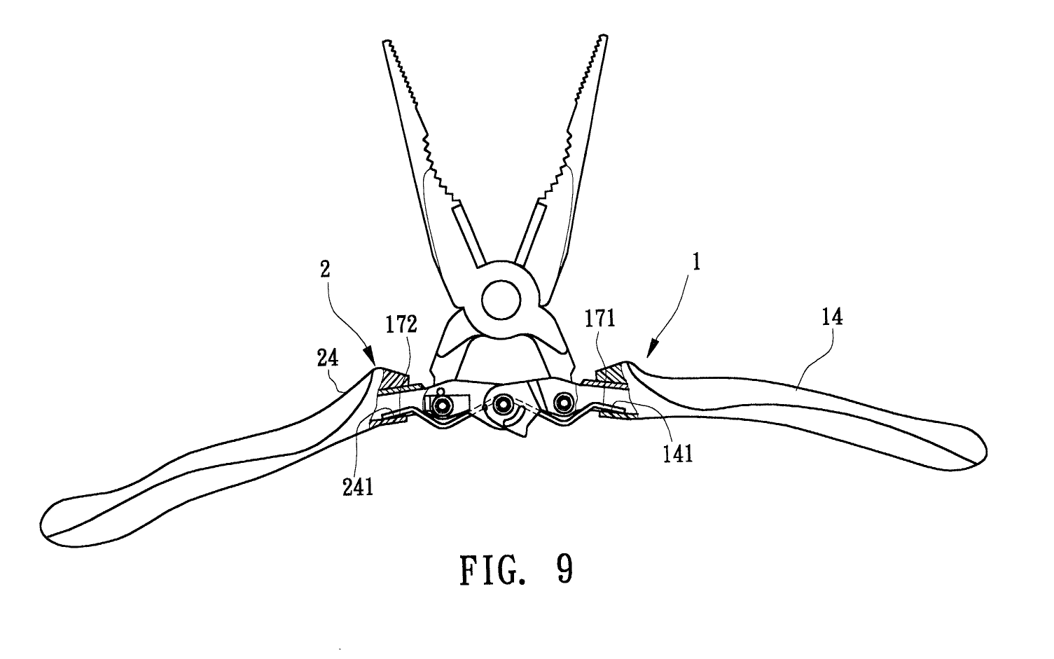

FIG. 9 shows a second embodiment of the present invention, in which the sheaths 14, 24 fitted on the handles 1, 2 are hollow, whereby the press sections 171, 172 of the torque spring 17 can extend into the sheaths 14, 24. The inner faces 141, 241 of the sheaths 14, 24 serve as stop faces for restricting the press sections 171, 172 of the torque spring 17 from protruding out of the handles 1, 2. Therefore, the second embodiment is able to achieve the same function as the first embodiment with the stop boards 18, 28 of the first embodiment omitted.

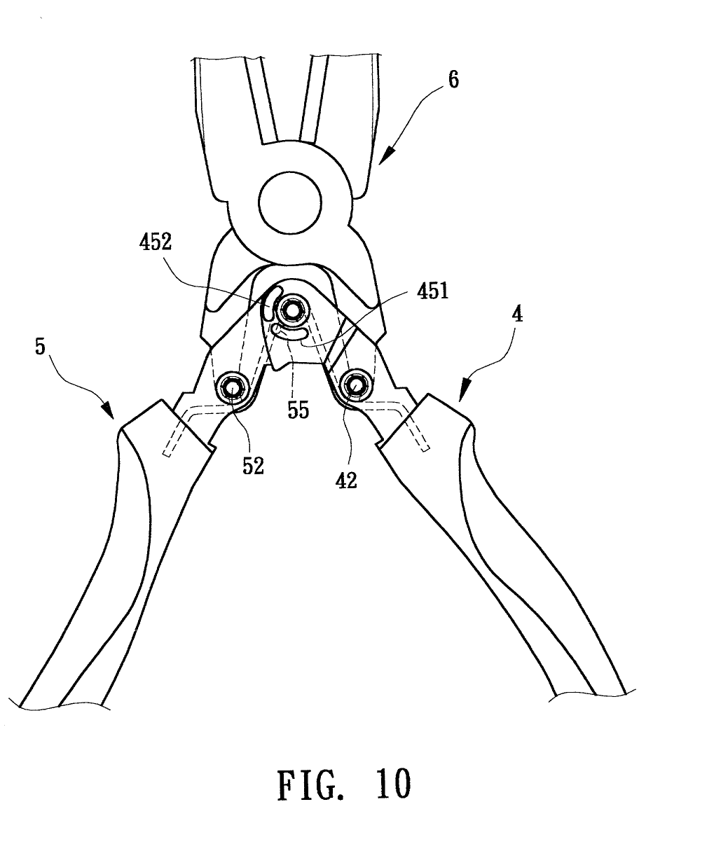

FIG. 10 shows a third embodiment of the present invention, in which the pivot holes (not shown) of the jaws 61, 62 have no opening. That is, after the pins 42, 52 are fitted in the pivot holes, the tool head 6 cannot be detached from the handles 4, 5. In such structure, the handle 4 is formed with a first slot 451 and a second slot 452 at intervals. The first and second slots 451, 452 are positioned in the moving path of the projecting block 55 of the handle 5 respectively when the handles 4, 5 are relatively pivoted by a smaller open angle and a larger open angle.

When the projecting block 55 is positioned within the first slot 451, the open angle of the handles 4, 5 is restricted within a smaller range and the tool is suitable for clamping a general work piece. When clamping a larger work piece, the handles 4, 5 are forcedly opened. At this time, the projecting block 55 will press the periphery of the first slot 451 to make the side board 403 flexed and deformed and the projecting block 55 will get out of the first slot 451. When the handles 4, 5 are pivoted to a position where the projecting block 55 is aimed at the second slot 452, the side board 403 will resiliently restore and get into the second slot 452. Therefore, the projecting block 55 is restricted within the second slot 452 and the open angle of the handles 4, 5 is restricted within a larger range and the tool can be more conveniently used to clamp a large work piece.

The above embodiments are only used to illustrate the present invention, not intended to limit the scope thereof. Many modifications of the above embodiments can be made without departing from the spirit of the present invention.

What is claimed is:

1. A tool comprising two handles and a tool head, wherein:
the tool head is composed of two clamping members middle portions of which are pivotally connected on a pivot shaft, one end of each clamping member having a pivot hole for pivotally connecting with the handles; and
each handle has a pivoted end, the pivoted ends being pivotally connected with each other on a shaft, a section of each handle near the pivoted end being formed with a caved section laterally passing through the handle, the handle being divided by the caved section into two side boards, a pin being disposed between the two side boards of each handle, the pins being fitted in the pivot holes of the clamping members, whereby when the handles are pivoted relative to each other, the pivotally connected clamping members are driven and pivoted, at least one side board of one of the handles having a projecting block, while one side board of the other of the handles being formed with at least one slot cooperating with the projecting block, the slot being positioned in the moving path of the projecting block when the handles are relatively pivoted, whereby by means of cooperation between the slot and the projecting block, the pivoting range of the handles is restricted.

2. The tool as claimed in claim 1, wherein one of the handles is formed with two slots at intervals, the slots being positioned in the moving path of the projecting block of the other of the handles when the handles are relatively pivoted.

3. The tool as claimed in claim 1, wherein a switch block is pivotally disposed on one of the handles, the handle having a protuberance on one side of the switch block distal from the other handle, whereby the switch block can be pivoted to lean against the protuberance, the other handle being formed with a stop face corresponding to the switch block, one side of the switch block adjacent to the protuberance being defined with a first leaning face and a second leaning face in accordance with the pivoting direction, whereby when the handles are closed, with the second leaning face of the switch block leant against the protuberance, the switch block abuts against the stop face to prevent the handles from rotating, while when the switch block is pivoted to lean the first leaning face against the protuberance, the switch block will not contact with the stop face.

4. The tool as claimed in claim 1, wherein the handles have asymmetrical patterns, an outer side of a section of one of the handles near the shaft being formed with a grip section bent toward the other of the handles and having larger arched recess.

5. The tool as claimed in claim 1, wherein a torque spring is fitted on the shaft of the handles, two ends of the torque spring extending from the opposite sides of the handles and passing by the pins of the handles and then outward extending to respectively form two press sections abutting against the handles, the opposite sides of the handles being respectively formed with two stop boards for stopping the press sections of the torque spring.

6. The tool as claimed in claim 5, wherein the handles are integrally bent to respectively form the two stop boards.

7. The tool as claimed in claim 5, wherein two sheaths are respectively fitted on the handles, the sheaths being hollow and the press sections of the torque spring extending into the sheaths, whereby inner faces of the sheaths form the stop boards.

8. The tool as claimed in claim 1, wherein the pivot hole of each clamping member of the tool head has an opening, the pin of each handle having a non-circular cross-section with a narrowed section, the openings being slightly larger than the narrowed sections, the handle with the slot being formed with a dent corresponding to the projecting block of the other handle, whereby when the handles are pivoted to a positioned where the narrowed sections of the pins can be detached and moved out of the pivot holes through the openings, the projecting block is engaged in the dent to locate the handles.
